(19) United States
(12) Patent Application Publication
(10) Pub. No.: US 2016/0133451 A1
(43) Pub. Date: May 12, 2016

(54) METHOD AND APPARATUS TO GENERATE BEAMS OF IONS WITH CONTROLLED RANGES OF MOBILITIES

(71) Applicant: Sociedad Europea de Analisis Diferencial de Movilidad, Madrid (ES)

(72) Inventor: Guillermo Vidal-de-Miguel, Zurich (CH)

(21) Appl. No.: 14/934,313

(22) Filed: Nov. 6, 2015

Related U.S. Application Data
(60) Provisional application No. 62/077,412, filed on Nov. 10, 2014.

(51) Int. Cl. H01J 49/06; H01J 49/10

(52) U.S. Cl. CPC H01J 49/062; H01J 49/10

(57) ABSTRACT

A method and apparatus that generate beams of ions with controlled ranges of mobility is described. Ions are introduced through an inlet in a channel. An axial electric field pushes the ions forward through said channel towards an outlet. The invention also incorporates regions in which ions are depleted, and which travel along said channel at a controlled velocity. These Regions are sequentially induced by locally applying a transversal electric field that deflects the ions away from the axis of said channel, or an axial field that pushes the ions backwards and deflects them away from said axis. Ions that travel at different velocity from the velocity of said regions eventually hit or are hit by said regions, and they do not reach the outlet, while ions of the selected mobility (which travel at the same velocity as said regions) travel through said channel unaltered and reach the outlet.

### CROSS-REFERENCE TO RELATED APPLICATION

This application claims the benefit of U.S. Provisional Patent Application No. 62/077,412, filed Nov. 10, 2014, the entire contents of which are incorporated by reference herein.

### FIELD OF THE INVENTION

The present invention relates to an apparatus and a method to select ions based on their electrical mobility. Ions are introduced through an inlet, separated according to their electrical mobility Z, and a band of mobility selected ions is transferred through an outlet.

### BACKGROUND OF THE INVENTION

The analysis of ions and charged particles according to their mobility is gaining increasing interest. Ion Mobility Spectrometry (IMS) is useful in the detection of trace species, such as explosives, chemical-warfare agents, biomarkers, etc [1]. It is also useful in the analysis for complex samples [2, 3], including petroleum [4, 5], biological samples [6, 7], proteins [6, 8-14], metabolites [15], and other samples. Different technologies enable for the separation of ions with according to their mobility.

### Separation in Time:

In a Drift Tube Ion Mobility Spectrometer (DT-IMS) [16], a packet of ions is introduced into a drift tube, in which a steady electric field pushes the ions forward. Each type of ions travels with a different velocity, and they arrive at the outlet at different times. In a Travelling Wave IMS (TW-IMS) [17], the electric field within the drift tube consists of Waves of intense electric fields, which travel along the tube and push the ions back and forth, creating a net averaged forward velocity which depends on the mobility. Ions in a TW-IMS are also outputted in short pulses, each arriving at different times. In these types of IMS, the mobility is associated with the time of arrival of the ions. As a result, the detector must be very fast in order to resolve the time varying output of ions. For this reason, these IMS are only coupled with Mass Spectrometers (MS) that can provide a very fast time response, such as Quadrupoles, and Time of Flight MS (TOF-MS). The Duty Cycle of these IMS is inherently very low (Due to their pulsed output). Nevertheless, the transmission of ions can be highly improved by the use of ion funnels [18], which enable for the accumulation of ions at the inlet, and multiplexing [19]. The use of ion funnels requires the pressure of the gas to be rather low (in the range of 1 Torr), and the outlet of the IMS has to be carefully integrated with the MS so as to retain the time information. As a result, the coupling between these IMS with the MS is usually intricate, and requires the tandem IMS-MS system to be developed as a compact (non-modular) architecture, resulting in very expensive systems.

### Separation in Space:

Field Asymmetric Ion Mobility Spectrometry (FAIMS) [20, 21] and Differential Mobility Spectrometry (DMS) [22-25] utilize a periodic and non-symmetrical electric field, which deflects the ions up and down at different electric filed intensities, and separates them according to their non-linear mobility behavior, which is defined by the parameter α (where a is defined by the expression: Z=Z₀(1+α(E)), in which E is the Electric field, Z is the mobility, and Z₀ is the mobility of the ions in the low field limit). Ions with different α follow different trajectories within the separation region, and only the ions that reach the outlet of the analyzer are transferred. These instruments provide a continuous output of selected ions, and hence coupling them with other analyzers is much easier. They can operate at atmospheric pressure, and be plugged upstream the inlet orifice of the MS, thus enabling an add-on architecture, which greatly reduces the cost of incorporating the mobility pre-separation onto pre-existing MS. However, FAIMS and DMS have one main disadvantage: in contrast with the absolute mobility, which is related with the cross section of the ions being analyzed, the physical interpretation of the parameter α is difficult to associate with molecular structures.

Differential Mobility Analyzers (DMA) [26] (see also the U.S. Pat. No. 7,928,374 B2 and, U.S. Pat. No. 7,838,821 B2) utilize a steady electric field and a perpendicular flow of high speed gas that deflects the trajectories of the ions. Ions enter the DMA through an inlet slit, each follows a different trajectory, which depends on the absolute mobility, and only ions reaching an outlet slit are transmitted. DMA also produce a continuous output of mobility selected ions, which greatly facilitates their coupling with the MS [27], but their performance is limited by the onset of turbulence (although this can be solved to a certain extent by a careful aerodynamic design)[28, 29]. And since the inlet and the outlet slits are geometrically offset-ed, they cannot be operated so as to transfer all ions regardless of their mobility (transparent mode). The transparent mode, although it might seem trivial, is especially important if more than one analyzer is coupled in series.

### Separation in Frequency:

Overtone Mobility Spectrometry (OMS), which is described in U.S. Pat. No. 7,838,821 B2 and in [3, 30-33] utilizes a series of segmented drift tubes, each with an inlet and an outlet, which define regions in which ions are pushed by the electric fields (in the drift tube regions), and regions where the ions are eliminated (in the space between drift tube regions: termed ion elimination region). The OMS also utilizes a number of M power supplies (activation sources), each of which creates an electric field that pushes the ions forward in all the drift tube regions and in all of the ion elimination region, except for one ion elimination region and the following M^{th} elimination regions. In these elimination regions, which are different for each power supply, the electric field is very strong, and eliminates the ions by diverting them towards the electrodes of the corresponding pair of outlet (of one drift tube) and inlet (of the subsequent drift tube) that define the ions elimination region. The power supplies of the OMS are turned on and off sequentially at a selected frequency. The ions which travel through the drift tube regions at a velocity that depends on their mobility, and hence the time of residence of the ions within teach drift tube depends on the mobility. According to the principle of operation of the OMS, those ions for which the time of residence equates with the period of the power supplies are transferred, while other ions are not. This condition is called fundamental frequency. But ions are not only transferred at their fundamental frequency. The ions for which the period is an integer fraction of their time of residence are also transferred by the OMS. These transmission condition is called Overtone. Interestingly, the resolving power measured at the overtone peaks is higher than the fundamental frequency[30], hence the name of the technique.

For the purpose of the present invention, it is interesting to introduce the diagrams ω-τ, where ω is the dimensionless ratio between the time of residence of the ions within the instrument over the period of the applied voltage, as defined in equation e1:

ω=lf/ZE (e1)

(where l is the characteristic length of the instrument, f is the frequency of operation of the instrument, Z is the mobility of the ions, and E is the characteristic electric field strength within the instrument).

And τ is the dimensionless ratio of the natural time over the period of the applied voltage, as defined in equation e2:

τ=tf (e2)

(where t is the natural time, and f is the frequency of operation of the instrument).

FIG. 1A illustrates the theoretical conditions at which ions are transferred through an OMS, which incorporates two power supplies (also termed phases by Clemmer el al.) and 22 drift tubes in series. The shadowed areas (101) of the ω-τ domain (102) represent the ions which are not transferred, while the clear areas (103) represent the ions which are transferred. As explained by Clemmer and colleagues, this system provides a duty cycle of 50% (meaning that the selected ions are transferred during 50% of the duty cycle). FIG. 1B illustrates, as a function of the parameter co, the time averaged output (104) of the OMS, which produces a peak at the fundamental frequency (105) (ω=1), and also at overtone frequencies (106): ω=1, 3, 5, . . . and so on.

When more phases are involved, the overtone pattern becomes more complex, as described in [32]. FIG. 2A illustrates the theoretical conditions at which ions are transferred through an OMS, which incorporates three power supplies (also termed phases by Clemmer el al.) and 24 drift tubes in series. The shadowed areas (101) of the ω-τ domain (102) represent the ions which are not transferred, while the clear areas (103) represent the ions which are transferred. As explained by Clemmer and colleagues, this system provides a duty cycle of 66.6% (meaning that the selected ions are transferred during 66.6% of the duty cycle). FIG. 2B illustrates, as a function of the parameter co, the time averaged output (104) of the OMS, which produces a peak at the fundamental frequency (105) (ω=1), and also overtone peaks at overtone frequencies (106): ω=1, 2.5, 4, 5.5 . . . and so on. In general, the overtones produced by an OMS having φ phases are known, and they follow the equation e3 [32, 33]:

$$ω = φ ( \frac{q}{φ - k} ) + 1 \qquad ( e 3 )$$

In which k is any integer number ranging from 0 to φ−1, and q is any integer number from 1 to ∞.

Variable Electric Field Mobility Analyzer (VEFMA) (also termed Transversal Modulation Ion Mobility Spectrometry (TMIMS) in publication [34]) also produces a continuous output of mobility selected ions. In a VEFMA, ions form a thin ion beam, and they are pushed in an axial direction by a steady electric field, which is generated by two opposed axial electrodes (the inlet and the outlet electrodes). A transversal and oscillating field, which is generated by two more electrodes (deflector electrodes) located between the axial electrodes, deflects the ions in a transversal direction. The time of residence of the ions within the VEFMA depends on their mobility (it is, in first approximation, equal to the distance between the axial electrodes divided by the axial electric field and the mobility of the ions). When the period of the oscillating field equates with the time of residence of the ions, the total transversal deflection is zero, and ions arrive at an outlet slit (regardless of the initial time at which they enter through the inlet slit of the VEFMA) because the deflection in one direction is compensated with the deflection in the opposite direction. FIG. 3A illustrates the theoretical conditions for which ions reach the outlet slit of the VEFMA in the ω-τ domain (102) (where co is now defined as in equation e1, in which now f is the frequency of the oscillating electric field, l is the distance between the inlet electrode and the outlet electrodes of the VEFMA, and E is the axial electric field; and where τ is defined as in equation e2, in which f is the frequency of the oscillating electric field, and t is the time at which ions pass through the inlet slit). The shadowed regions (101) of the ω-τ domain (102) correspond with ions that are not transferred, while the clear regions (103) correspond with ions that are transferred. FIG. 2B illustrates, as a function of the parameter co, the time averaged output (104) of the VEFMA, which produces a peak at the fundamental frequency (ω=1), and also overtone peaks at frequencies: ω=1, 2, 3, and so on.

By switching off the oscillating fields of the VEFMA, all ions can be transferred directly from the inlet slit towards the outlet slit regardless of their mobility. As a result, VEFMA can also be operated in transparent mode. OMS can also pass all ions, and it can also be used as a regular Drift Tube, which can be very advantageous in certain conditions. OMS and VEFMA provide a continuous output of mobility selected ions, as DMAs do. Yet, they can be operated in transparent mode, and they are not subjected to the turbulence related problems of the DMAs since they do not involve high speed flows.

However, these technologies have one important problem: the overtones peaks hinder a direct assignment between frequencies and mobilities.

### The Problem of Overtones:

Ideally, one mobility should be linked to one (and only one) frequency. The frequency and the mobility should be associated in a one-to-one correspondence: One mobility should correspond only with one frequency, and one frequency should correspond only with one mobility. In this manner, the signals observed at a particular frequency, would be easily assigned to a particular mobility. However, with the OMS and the VEFMA, due to the fact that one mobility produces several peaks at different frequencies, it is impossible to assign one single mobility to a given frequency. For instance, for a given frequency f of the VEFMA, the possible mobilities that could be associated with this frequency are Z′ (where Z′ is the mobility for which ω=1 at the particular frequency) and also Z′/2, Z′/3, Z′/4, and so on. For an OMS with two phases, the possible mobility assignments would be Z′, Z′/3, Z′/5, and so on, and for an OMS with φ phases, the possible assignments would be given by equation e4:

$$Z = {Z}^{′} ( \frac{φ - k}{φ ( q + 1 ) - k} ) \qquad ( e 4 )$$

(where k is any integer number ranging from 0 to φ−1, and q is any integer number from 1 to ∞).

The difficulty to assign frequency measurements to mobilities is an important problem, since the ultimate physical property that IMS instruments measure is the mobility. This problem can be partially addressed by scanning over the frequency so as to identify the fundamental frequency. However, scanning the frequency reduces drastically the overall duty cycle of the instruments, and is very time consuming.

An attempt to solve this problem for the VEFMA is described by the inventor of the present invention in U.S. Pat. No. 8,378,297 B2, the contents of which are incorporated herein by reference. U.S. Pat. No. 8,378,297 B2 describes an axial electric field and a counterflow that form a tunable high mobility filter, which would in principle eliminate all ions with mobilities below a tunable threshold. As described in U.S. Pat. No. 8,378,297 B2, the resolving power (R) required to transfer the mobility of interest Z′ and to eliminate the rest of mobilities Z′/2, Z′/3, etcetera, is R=2. Although this performances might seem to be easily attainable with the architecture of U.S. Pat. No. 8,378,297 B2, it is in fact not. The flows required by the high mobility filter of U.S. Pat. No. 8,378,297 B2 can be easily estimated for the simplified case in which the electric field and the flow velocities are uniform: In order to produce a flow of ions of mobility Z′ high enough to match the flow sampled by the instrument (Qᵢ), the electric flux (Qₑ, which pushes the ions forward), and the counterflow (Q_{f}, which drags the ions backwards) that pass through the high mobility filter must satisfy the following equation:

QₑZ′−Q_{f}=Qᵢ (e5)

On the other hand, if a mobility threshold if defined at a mobility Z′η (where η is a real number which must be higher than ½ to eliminate the overtone Z′/2, and lower than 1 to pass the mobility Z′), for which the flow of ions is zero, then the following equation must be satisfied:

QₑηZ′−Q_{f}=0 (e6)

These two equations combined yield the counterflow which would be required by an ideal high pass mobility filter operating with uniform fields and gas flows:

$${Q}_{f} = {Q}_{i} \frac{η}{1 - η} \qquad ( e 7 )$$

Equation e7 shows that, for a typical flow of Qᵢ=3.5 lpm, and for η=0.75 (between 1 and 0.5), the required counterflow would be 10.5 lpm. At this flow rate, and for the typical size of the VEFMA inlet slit (0.5 mm times 1 cm) the Reynolds Number of the gas flow is near Re=1000, which inevitably lead to turbulent prone flows (since the flow path is not straight and leads to detachment regions and stagnation regions), which mix the trajectories of the ions, and which thus lead to a very inefficient separation of ions. On top of this, it is well known that the gas velocity profile of the counterflow configuration cannot be uniform because the gas travels at lower velocities near the walls, and is stagnated in the boundary layers. As a result, low mobility ions are transferred through these regions with low gas velocities, and the equation e7 is only valid in the central region of the counterflow jet. This problem can be partially compensated by increasing the flow Q_{f}, and by deflecting the ions of the outer parts of the ion beam. However, the required Q_{f} becomes even higher, and the turbulent associated problems become even more significant. In short, the proposed high pass filter of U.S. Pat. No. 8,378,297 B2 does not solve the problem of eliminating the overtones produced by the VEFMA.

For the case of the OMS, the problem is even more demanding. Since the OMS provides a better resolving power at high overtones, it would be desirable to isolate one overtone from the tones corresponding with lower mobilities (for this, a high mobility pass filter would be required), and also from other tones corresponding with lower mobilities (for this, a low mobility pass filter would be required). As a result, the isolation of the overtone of interest in an OMS would require a mobility band pass filter.

In short, there is no known solution for the problem of passing selectively only one of the mobilities that the VEFMA passes at a frequency of operation, so that the correspondence between frequency and mobility is a one-to-one correspondence. Consequently, one objective of the present invention is to solve the problem of passing selectively only one of the mobilities that the VEFMA passes at a frequency of operation, so that the correspondence between frequency and mobility is a one-to-one correspondence.

There is also no known solution for the problem of passing selectively only one of the mobilities that the OMS passes at a frequency of operation, so that the correspondence between frequency and mobility is a one-to-one correspondence. Consequently, one objective of the present invention is to solve the problem of passing selectively only one of the mobilities that the OMS passes at a frequency of operation, so that the correspondence between frequency and mobility is a one-to-one correspondence.

### The Problem of Secondary Peaks:

The VEFMA also has another problem, which is described in U.S. Pat. No. 8,378,297 B2: the non-selected ions produce a pulsed output, which leads to a non-zero background, as illustrated in FIG. 3B. An attempt to solve this problem is also described in U.S. Pat. No. 8,378,297 B2. According to this patent, by operating two VEFMA stages in quadrature, the phase for which non-selected ions pass through the outlet slit of the first stage coincides with the phase for which non-selected ions are deflected in the second stage, and non-selected ions are thus eliminated. While this holds true for the majority of non-selected ions, there are some phases and some mobilities for which non-selected ions still pass through the outlet slit of the first and the second stages, thus producing some secondary peaks. FIG. 4 shows three spectra obtained by the inventor of the present invention with an experimental 2 stages VEFMA coupled with a triple quadrupole Atmospheric Pressure Interface Mass Spectrometer (API-MS), in which an electrospray of Tetra Heptyl Ammonium Bromide (THABr) was used to generate TetraHeptyl Ammonium ions.

The two stages VEFMA used to acquire the spectra of FIG. 4 was composed of two symmetrical insulator boxes, the first (Stage 1) housing the inlet electrode, and the second (Stage 2) housing the outlet electrode, while both housed two cylindrical deflector electrodes. Each stage was 5 cm long, the diameter of the deflector electrodes was 3 cm, and their centers were 7 cm apart. The slit of the inlet electrode (inlet slit) communicated with a gas-tight nano-electrospray (nanoESI) chamber, and a focusing plate, with a 4 mm wide slit, was located between the n-ESI tip and the inlet slit so as to guide the ions towards the inlet slit. The intermediate electrode consisted of a thin plate (0.5 mm thick) that separated the two stages, and which incorporated a slit (intermediate slit) that allowed ions reaching the slit to be transferred towards the second stage. The outlet electrode incorporated a slit which was elongated on the side receiving the selected ions, and which smoothly transitioned towards a rounded orifice on the opposite side of the electrode so as to better fit the inlet of the following API-MS.

The spectra of FIG. 4 show the signal of tetra-heptyl ammonium (THA+) ions as a function of the frequency of the VEFMA. The dashed lines (107) correspond to the signals measured when the oscillating electric field was applied only to one stage (stage 1 and stage 2 respectively), so that the other stage passed all ions regardless of their mobility. The high background levels (108) measured when only one stage is functioning are produced by the pulsed output of undesired ions, which is explained in our previous work[34]. These spectra also show the main peak (109), which appears at the fundamental frequency (105), and the first overtone (106).

The solid line (110) shows the signal acquired when the two VEFMA stages were operated with their respective oscillating fields in quadrature. This figure illustrates how the two stages together can eliminate most of the pulsed output. It also shows very clearly the main peak (109) at the fundamental frequency (105), and the first overtone (106). One could think that the secondary peaks (111) appearing in the spectrum could be produced by different clusters of the THA+, which would be separated in the VEFMA and then declustered in the API interface, thus appearing at the mass of the dried THA+ ions. However, the mobilities at which these peaks appear do not match any of previously reported clusters[35], and the peak appearing at near 400 Hz did not appear when only one stage was used. A similar pattern is also observed with other types of ions. In view of this, we concluded that these peaks are an artifact produced by the instrument.

The origin of these secondary peaks can be better explained in the ω-τ domain (102). FIG. 5A illustrates the theoretical conditions for which ions that reach the intermediate electrode at time t pass through the intermediate slit (and thus pass from the first stage to the second stage). FIG. 5B illustrates the theoretical conditions for which ions that reach the intermediate electrode at time t can also reach the outlet slit (and are thus transferred downstream the VEFMA). FIG. 5C illustrates the ions which pass through the first stage and then through the second stage. It shows that ions are continuously transferred at the fundamental frequency and also at the overtone frequency, and it also shows that non-selected ions still produce a pulsed output at specific frequencies. In these figures, ω is now defined as in equation e1, in which now f is the frequency of the oscillating electric field, l is the distance between two adjacent axial electrodes (inlet to intermediate, or intermediate to outlet), and E is the axial electric field; and where τ is defined as in equation e2, in which f is the frequency of the oscillating electric field, and t is the time at which ions reach the intermediate electrode). The shadowed regions (101) of the ω-τ domain (102) correspond with ions that are not transferred, while the clear regions (103) correspond with ions that are transferred. Finally, FIG. 5D shows the theoretically predicted spectrum (112), which produces the secondary peaks (111) due to non-selected ions (113) which are still transferred through the two stages VEFMA of U.S. Pat. No. 8,378,297 B2. It also shows the fundamental peak (109, 105) and the first overtone (106)

Despite the fact that the invention of U.S. Pat. No. 8,378,297 B2 eliminates most of the non-selected ions, it still produces the secondary peaks (111), which complicate even further the spectra and the correspondence between the measured frequency, and the mobility. Consequently, one objective of the present invention is to eliminate said secondary peaks

### SUMMARY OF THE INVENTION

The present invention provides a new way to select ions (201) and other charged particles according to their mobility. Ions are introduced through an inlet (202) in a channel (203) (characterized by its length l) in which an axial electric field (204) pushes them forward towards an outlet (205), which is located at the opposite side of said channel (203). A gas is also introduced in said channel (203), and ions travel through said channel (203) at a velocity that depends on their mobility. By applying a transversal electric field to at least one region of said channel (said regions characterized by their length d), or by applying an axial electric that pushes the ions backwards in said regions, ions are depleted in said regions. In the present invention, said regions travel at a controlled velocity through said channel (hence, they are termed Travelling Depletion Regions (206)). Said regions are introduced following a periodic sequence. Ions that travel at a velocity which is different from the velocity of said Travelling Depletion Regions (206) eventually hit said region or are hit by said region, while ions that travel at the same velocity as said Travelling depletion region are mostly unaltered by said travelling depletion region. As a result, ions of the selected mobility (for which the velocity equals the velocity of the travelling Depletion region) are transferred, while ions with different mobilities are deflected away, do not reach the outlet (205), and are not transferred.

By narrowing the band of mobilities that are transferred, the present invention can be used on its own as a scan-able mobility filter. Alternatively, the present invention can be coupled with other mobility analyzers such as OMS and VEFMA (207), which already provide a good resolving power, in order to selectively pass only one of the peaks (either the main peak or a selected overtone) and to eliminate the rest of undesired overtone (106) peaks and secondary peaks (111). Combined with VEFMA (207) or OMS, the present invention allows to take full advantage of the high resolving power provided by these techniques, while also ensuring that the correspondence between frequency and mobility is a one-to-one correspondence.

### BRIEF DESCRIPTION OF THE DRAWINGS

FIG. 1A (Prior Art) illustrates schematically the pattern of transmitted ions in a OMS with two phases, and in the ωτ domain.

FIG. 1B (Prior Art) illustrates schematically the spectrum resulted by averaging in time the output of ions of FIG. 1A.

FIG. 2A (Prior Art) illustrates schematically the pattern of transmitted ions in a OMS with three phases, and in the ωτ domain.

FIG. 2B (Prior Art) illustrates schematically the spectrum resulted by averaging in time the output of ions of FIG. 2A.

FIG. 3A (Prior Art) illustrates schematically the pattern of transmitted ions in a VEFMA with one stage, and in the ωτ domain.

FIG. 3B (Prior Art) illustrates schematically the spectrum resulted by averaging in time the output of ions of FIG. 3A.

FIG. 4 (Prior Art) illustrates schematically the measured spectrum produced by a two stages VEFMA. This figure shows the main peak, an overtone corresponding with the double frequency, and the secondary peaks.

FIG. 5A (Prior Art) illustrates schematically the pattern of transmitted ions in the first stage of a two stages VEFMA, and in the ωτ domain.

FIG. 5B (Prior Art) illustrates the pattern of transmitted ions in the second stage of a two stages VEFMA, and in the ωτ domain.

FIG. 5C (Prior Art) illustrates the pattern of transmitted ions that are transmitted through both the first and the second stages of a two stages VEFMA, and in the ωτ domain.

FIG. 5D (Prior Art) illustrates schematically the spectrum resulted by averaging in time the output of ions of FIG. 5C.

FIG. 6 illustrates schematically the principle of operation of one single Travelling Depletion Region. Over-speeding ions and down-speeding ions hit the Travelling Depletion Region, while ions that travel at the same velocity as the Travelling Depletion Region travel unperturbed through the channel.

FIG. 7A illustrates schematically the pattern of transmitted ions in the present invention, in the ωτ domain, when only one Travelling depletion region is applied through the channel.

FIG. 7B illustrates schematically the pattern of transmitted ions in the present invention, in the ω-τ domain, when a Travelling depletion region is periodically started at the inlet of the channel every time the previous travelling Depletion region reached the outlet of the channel.

FIG. 7C illustrates schematically the pattern of transmitted ions in the present invention, in the ω-τ domain, when the Travelling depletion regions are periodically started with a period which is half the time required by each Travelling Depletion region to traverse the channel from the inlet to the outlet.

FIG. 8 illustrates schematically a Transversal Travelling Depletion Region Filter, in which the channel is formed be a sequence of pairs of planar electrodes that form a sequence of slits, in which the inlet is defined by the first slit, the outlet is defined by the last slit. Here, the depletion Regions are created by applying a voltage drop between the electrodes of each pair of electrodes, such that a transversal electric field in the proximity of said pair of electrodes. This transversal electric field deflect the ions laterally toward the electrodes, where they are neutralized upon contact with the electrodes. By sequentially applying said voltage to each pair of electrodes, a virtual Travelling deflection region is generated.

FIG. 9 illustrates schematically, in the domain defined by the time (t) and the axial coordinate along the channel (x), the regions affected by three types of travelling deflection regions, and the trajectories of the different ions. In particular, this figure illustrates the interaction between ions and: (i) an ideal Travelling depletion region, (ii) a virtual travelling depletion region (which jumps from one fixed position to the next with an averaged velocity, and which defined a solid depleting region in the t-x domain), and (iii) a set of depletion regions which are not overlapped and which do not produce a solid depletion region in the t-x domain.

FIG. 10 illustrates schematically an Axial Travelling Depletion Region Filter, in which the channel is formed be a sequence of planar electrodes that form a sequence of slits or orifices with an arbitrary shape, in which the inlet is defined by the first slit, the outlet is defined by the last slit. Here, the depletion Regions are created by applying an extra voltage drop between one electrode and an adjacent electrode, such that an axial electric field that pushes the ions backwards is created between said two electrodes. This electric field deflect the ions radially toward the electrodes, where they are neutralized upon contact with the electrodes. By sequentially applying said voltage to each electrode, a virtual Travelling deflection region is generated.

FIG. 11 illustrates schematically the Transversal Depletion Region Filter coupled with one stage VEFMA.

FIG. 12A illustrates, in the ωτ domain, the pattern of transmitted ions through a Travelling Depletion region Filter, when four different phases: (φ₁=0, φ₂=0.15, φ₃=0.4, φ₄=0.7) are utilized.

FIG. 12B illustrates schematically the pattern of transmitted ions in a VEFMA with one stage, and in the ωτ domain.

FIG. 12C illustrates, in the ωτ domain, the pattern of transmitted ions through a Travelling Depletion region Filter coupled with a one stage VEFMA, when four different phases: (φ₁=0, φ₂=0.15, φ₃=0.4, φ₄=0.7) are utilized.

FIG. 12D illustrates schematically the spectrum resulted by averaging in time the output of ions of FIG. 12C.

FIG. 13 illustrates schematically the Transversal Depletion region Filter coupled with a two stages VEFMA.

FIG. 14A illustrates, in the ωτ domain, the pattern of transmitted ions through a Travelling Depletion region Filter, when only one TDR is generated each time the previous TDR arrives at the outlet of the TDR Filter.

FIG. 14B illustrates schematically the pattern of transmitted ions in a VEFMA with two stages, and in the ωτ domain.

FIG. 14C illustrates, in the ωτ domain, the pattern of transmitted ions through a Travelling Depletion region Filter coupled with a two stages VEFMA, when only one TDR is generated each time the previous TDR arrives at the outlet of the TDR Filter.

FIG. 14D illustrates schematically the spectrum resulted by averaging in time the output of ions of FIG. 14C.

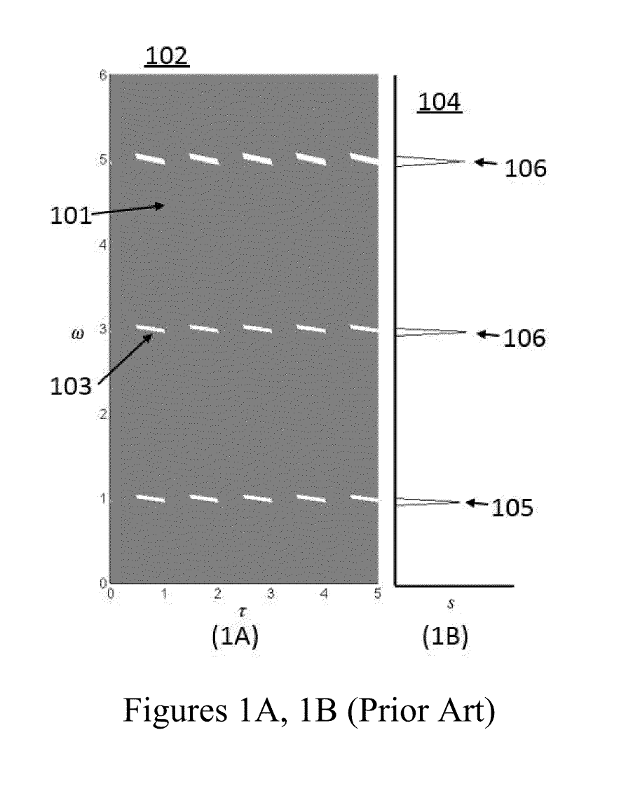

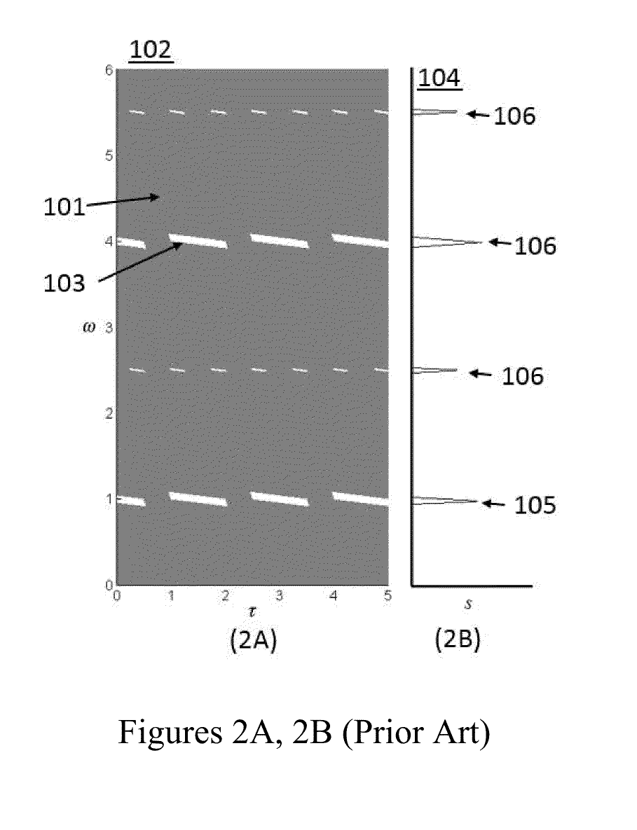

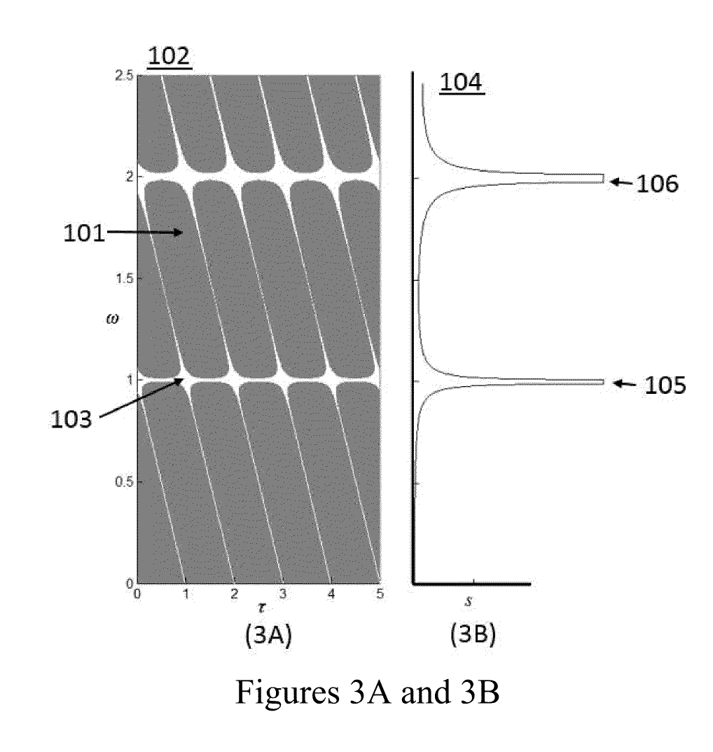

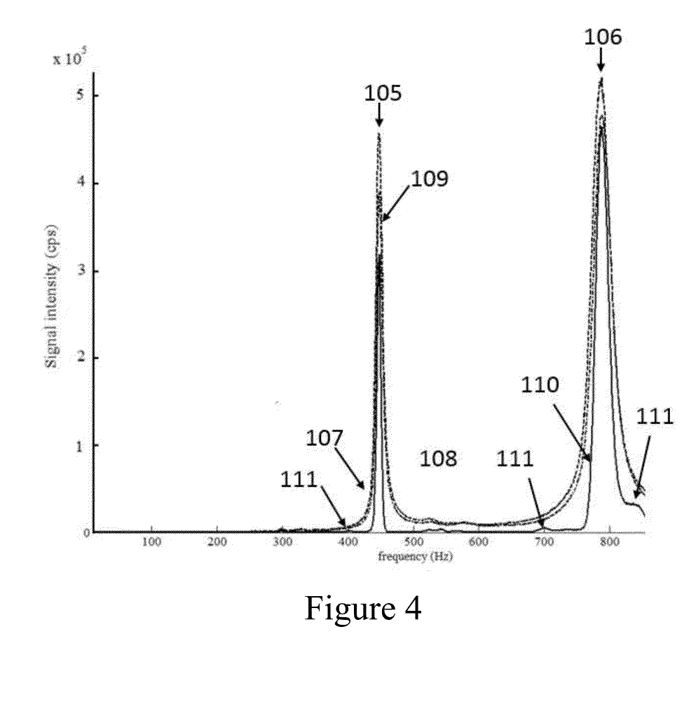

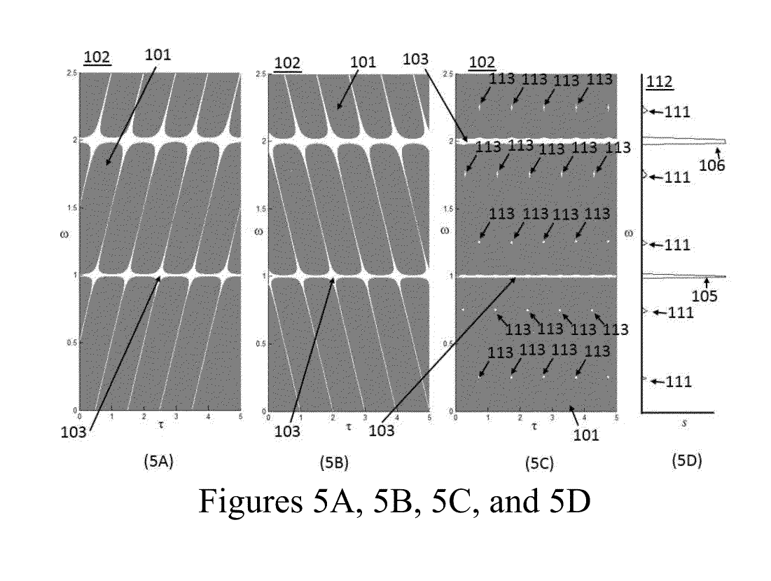

### MORE DETAILED DESCRIPTION OF THE INVENTION

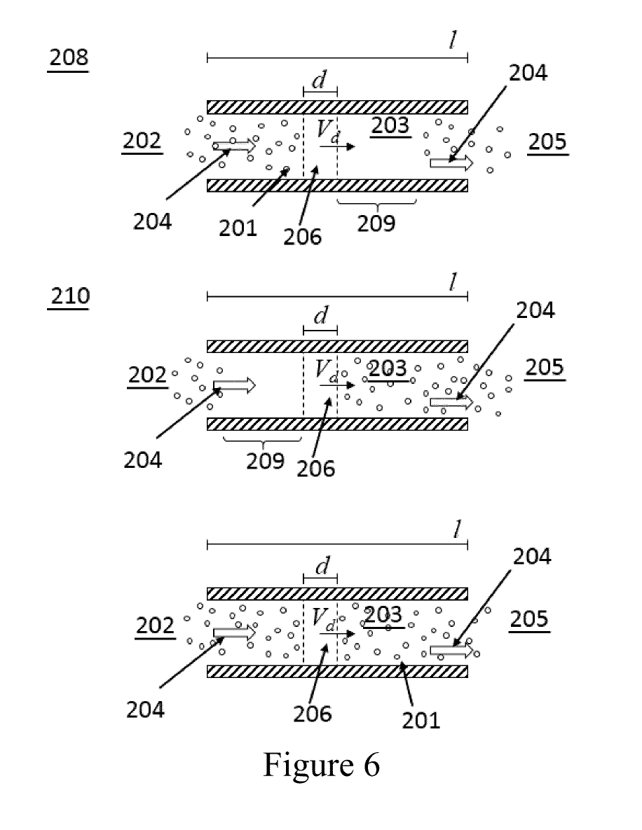

The Travelling Depletion Region (206): FIG. 6A illustrates a basic new component of the present invention. In the present invention, ions (201) are continuously introduced in a channel (203), which is filled with a gas and has a length (l), and in which an axial electric field (204) (Eₐ) pushes the ions forward at a velocity which is proportional to their mobility. Said channel (203) having an inlet (202) and an outlet (205). In the new invention, at least one region in which ions are depleted also travels along said channel at a controlled velocity V_{d}. Said region or regions, which are characterized by their length (d), are here termed Travelling Depletion Region (TDR) (206). Ions (201) are continuously introduced in the channel through the inlet (202). Those ions that travel at the same velocity as the TDR (206) are eliminated only if they are introduced in the channel at the same time as the TDR (206) is started. All the rest of ions that travel at the same velocity as the TDR, but which travel either in front of the TDR (206) or behind the TDR (206), are not affected by the TDR. As a result, those ions traverse said channel (203), and reach the end of said channel, where they are outputted through said outlet (205). Over-speeding ions (208), which travel at a higher velocity than V_{d}, reach the TDR (206) and are eliminated. As a result, a region emptied (209) of these over-speeding ions is produced downstream of said TDR (206). On the other hand, under-speeding ions (210), which travel at a lower velocity than V_{d}, are overtaken by the TDR (206), and they are eliminated. As a result, a region emptied (209) of these under-speeding ions is produced upstream of said TDR (206). As a result, the TDR (206) eliminates the ions that travel at the speed V_{d} only for a small fraction of time, while other ions are eliminated for a larger fraction of time. Equation e8 shows the duration of the fraction of time during which ions are eliminated by a TDR (206):

$$Δ t = \frac{d}{{V}_{d}} + \vert \frac{l}{{ZE}_{a}} - \frac{l}{{V}_{d}} \vert \qquad ( e 8 )$$

The mobility for which the TDR eliminates ions for a smaller fraction of time can be selected simply by changing either Eₐ or V_{d}.

The effect of a TDR can be better evaluated in the diagrams ω_{d}-τ, where ω_{d} is the dimensionless ratio between the time of residence of the ions within the instrument, over the time of residence of the TDR, which equals the ratio of the velocity of the TDR (V_{d}) over the velocity of the ions:

ω_{d}=V_{d}/ZEₐ (e9)

And τ is the dimensionless ratio of the natural time at the outlet of the channel over the time required for the TDR to traverse the channel:

τ=tV_{d}/l (e10)

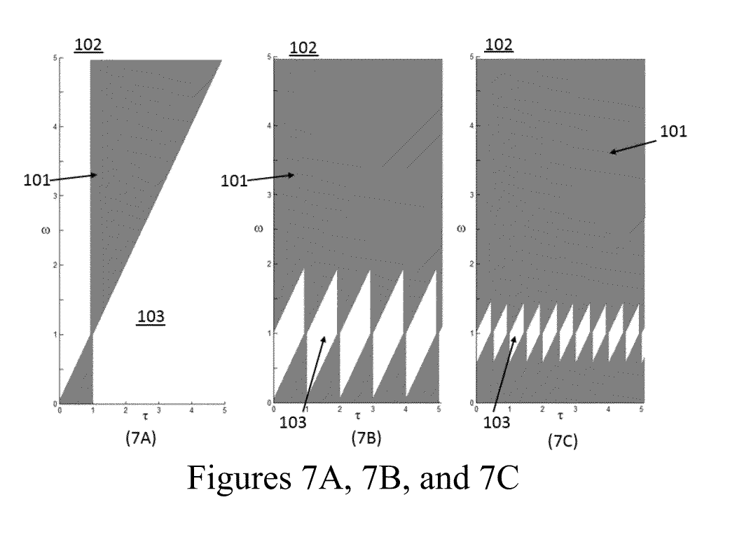

FIG. 7A is a representation, in the ω_{d}-τ domain (102), of the passage of ions when one TDR (206) is introduced a time t=0. The shadowed regions (101) of the ω_{d}-τ domain (102) correspond with ions that are not transferred, while the clear regions (103) correspond with ions that are transferred.

The TDR Mobility Band Pass Filter (TDR Filter):

By periodically starting a TDR (206), the present invention also enables to pass only a band of mobility selected ions. For instance, FIG. 7B illustrates the passage of ions when a new TDR starts its journey every time the previous TDR arrives at the outlet of the channel. In this particular case, ions that travel at the same velocity as the TDR (V_{d}) are outputted by the device with a very high duty cycle, which is given by the expression: DC=1−d/l. Ions that travel at lower speeds than V_{d} also produce a pulsed output, with smaller DC for ions travelling slower. For these ions, the Duty Cycle (DC) is given by the expression DC=2−d/l−V_{d}/(ZEₐ). This equation shows that ions travelling at a velocity V_{d}/(2−d/l) have a zero DC. Ions travelling at lower velocities are always overtaken by at least one TDR, and they are thus never transferred. Ions that travel at a higher velocities than V_{d} also produce a pulsed output. For them, the DC is given by the expression DC=V_{d}/(ZE)−d/l, which yields zero DC when ZE approaches V_{d}d/l. As illustrated by these equations, the configuration which comprises a channel (203) and one TDR (206) which is repeatedly started every time the previous TDR (206) arrives at the outlet of the channel, acts like a band pass mobility filter. In a more general situation, in which the TDR (206) is periodically started with a period T_{d}, the ions that travel at the same mobility as the TDR produce a pulsed output with a high duty cycle, which is given by the expression e11:

DC=1−d/V_{d}T_{d} (e11)

While ions that have mobilities within the range defined in inequations e12 produce a pulsed output with period T_{d}, and with a DC, which is maximal for those ions having a mobility Z′=V_{d}/Eₐ, and which is lower as mobilities differ from Z′.

$$\begin{matrix}\frac{\frac{{V}_{d}}{{E}_{a}}}{1 + \frac{{T}_{d} {V}_{d} - d}{l}} < Z & < \frac{\frac{{V}_{d}}{{E}_{a}}}{1 - \frac{{T}_{d} {V}_{d} - d}{l}}\end{matrix} \qquad ( e 12 )$$

Finally, ions that don't satisfy the inequations e12 do not react the outlet and are not transferred. As a result, the present invention provides a band-pass mobility filter with its low and high cutoff mobilities defined by the expressions e12, and with its maximum DC given by eq. e11. Lower values of T_{d} enable narrower mobility bands. For instance, FIG. 7C illustrates, in the ω_{d}-τ domain (102), the passage of ions for the particular case for which the period T_{d} is half the time required by a TDR (206) to traverse the channel.

In a more general description of the present invention, the different TDR (206) are arranged in an arbitrary sequence, which is repeated periodically. The set of Travelling Depletion Regions (206) is defined by a repetition period Tᵣ (the repetition interval of the sequence), the time required for each TDR to traverse the channel (Tₗ, this time defines the velocity V_{d}=l/Tₗ) and a dimensionless vector (φ₁, φ₂, φ₃, φ₄, . . . ) which defines the phase of each TDR. Accordingly, each TDR is started at times: {Tᵣφ₁, Tᵣφ₂, Tᵣφ₃, Tᵣφ₄, . . . Tᵣ+Tᵣφ₁, Tᵣ+Tᵣφ₂, Tᵣ+Tᵣφ₃, Tᵣ+Tᵣφ₄, . . . 2Tᵣ+Tᵣφ₁, 2Tᵣ+2Tᵣφ₂, 2Tᵣ+Tᵣφ₃, 2Tᵣ+Tᵣφ₄, . . . 3Tᵣ+Tᵣφ₁, 3Tᵣ+3Tᵣφ₂, 3Tᵣ+Tᵣφ₃, 3Tᵣ+Tᵣφ₄, . . . } and so on.

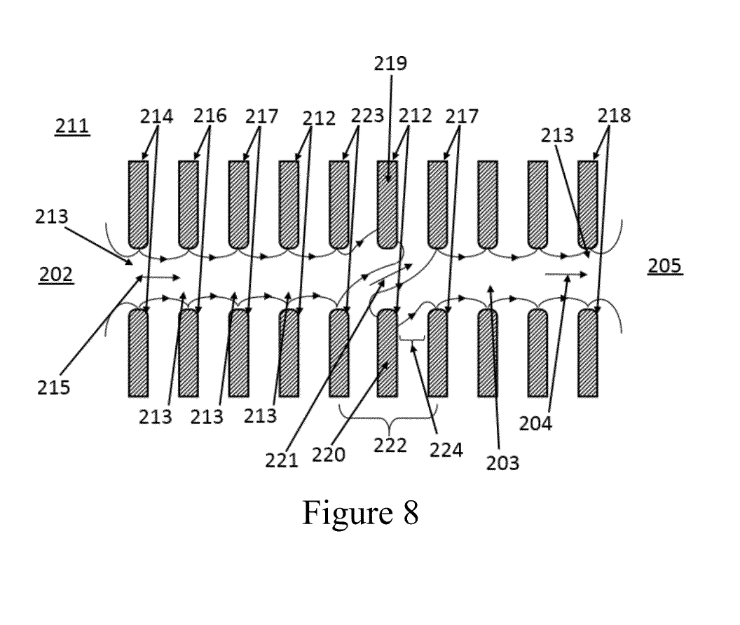

One embodiment of the TDR Filter, termed transversal TDR (211), is shown in FIG. 8. The channel (203) in this case is formed by a ladder of plate shaped pairs of electrodes (212). Each pair of electrodes defines a slit (213), and the plurality of pairs of electrodes define a channel (203). The ions enter the channel through the slit (213) defined by the first pair of electrodes (214), which defines the inlet (202). An axial voltage drop between the first pair of electrodes and the second pair of electrodes generates a local axial electric field (215) that pushes the ions from the first pair of electrodes (214) towards the slit (213) defined by the second pair of electrodes (216). Another axial voltage drop established between the second pair of electrodes (216) and the next pair of electrodes (217) also creates a local axial electric field (215) that pushes the ions towards the slit (213) defined between the next pair of electrodes (217). By repeatedly adding more pairs of electrodes (212) and more axial voltage drops, a channel (203) is formed in the space defined by the subsequent slits (213) defined by each consecutive pair of electrodes (212), and an axial electric field (204) that guides the ions along the channel (203) through the consecutive slits (213) is also defined. The last pair of electrodes (218) define a slit (213) which defines the outlet (205).

By increasing the voltage of one of the electrodes (219) in one pair of electrodes, while decreasing the voltage on the other electrode (220) of the same pair of electrodes (212), a transversal electric fields (221) is created in the region (222) formed between said pair of electrodes (212), and the two adjacent pairs of electrodes: the previous pair of electrodes (223) and the next pair of electrodes (217). As a result of said transversal electric field (221), ions in said region are deflected laterally, and they are not pushed towards the slit (213) formed between said next pair of electrodes (217). Instead, the electric field pushes the ions towards the electrode walls, where they are neutralized upon contact with said electrode walls, resulting in a quick and effective elimination of ions in the affected region (termed here Depletion Region DR) (222).

According to the present invention, said voltages that generate said transversal electric fields (221) (here termed transversal voltages) are applied first to the first pair of electrodes (214) for a controlled time t₁. After this, said transversal voltages are removed from the first pair of electrodes (214), and the transversal voltages are applied to the second pair of electrodes (216) for a time t₁. After this, said transversal voltages are removed from the second pair of electrodes, and the transversal voltages are applied to the next pair of electrodes (217) for a time t₁. And the same operation is repeated sequentially until the last pair of electrodes (218). As a result of this sequence, the consecutive Depletion Regions (222) form a virtual Travelling Depletion Region, which is still while the transversal voltages are applied, travels instantly when the transversal voltages are switched from one pair of electrodes (212) to the next (217), and which has an average velocity defined by V_{d}=dₑ/t₁ (where dₑ is the axial distance between the centers of two adjacent pairs of electrodes (212)).

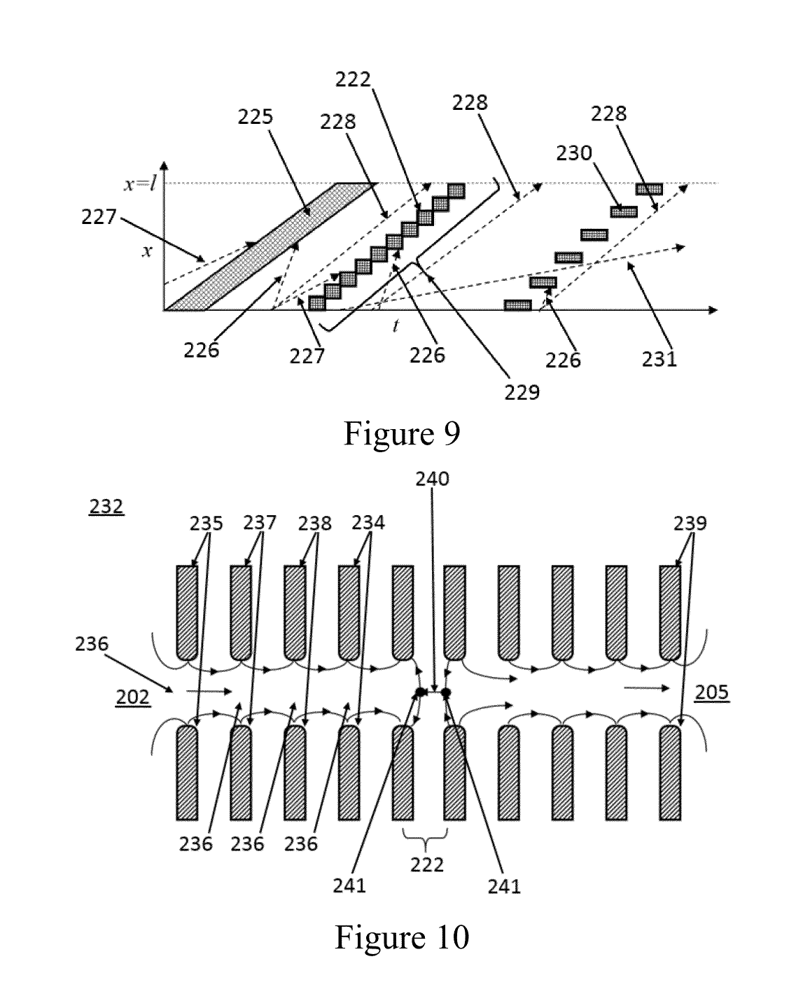

The Depletion Region (222) corresponding to one pair of electrodes (212) and the Depletion Region (222) corresponding to the next pair of electrodes (217) are overlapped in the space (224) defined between said pair of electrodes (212) and said next pair of electrodes (217). As a result, although the position of the center of said Virtual Travelling Depletion region changes almost instantly when the transversal voltage is removed from one pair of electrodes and it is applied to the next, the virtual Travelling Depletion Region travels in a continuum fashion. FIG. 9 illustrates this particular feature of the present invention. In this figure, the horizontal axis is the time, and the vertical axis is the axial coordinate of the channel. The effect of an ideal Travelling Depletion Region (206) is depicted by the shadowed area (225), which represents the time and the positions in which ions are depleted; over-speeding ions (226) and under-speeding ions (227) cross paths with the TDR (206) and are eliminated, while ions of the selected mobility (228) do not cross paths with the TDR (206) and they are transferred. A virtual TDR (229), in which the subsequent depletion regions (222) are overlapped, is represented by the shadowed area (229); the interactions between the different types of ions and the virtual TDR (229) is in this case very similar to that of the ideal TDR (206): over-speeding (226) and under-speeding ions (227) cross paths with the virtual TDR (229) and they are eliminated, while ions that travel at the same speed as the virtual TDR (229) do not collide with it and reach the outlet (at x=l). If the subsequent DR (222) are not overlapped, the corresponding shadowed area is no longer continuous (instead, it forms islands (230) in the time and axial coordinate domain). As a result, under-speeding ions that travel at a velocity significantly lower than V_{d}, (231) can pass between these islands (230). In one embodiment of the present invention, in order to avoid the passage of these under-speeding ions (231), the DR (222) are overlapped.

The geometry based on pairs of electrodes (212) that define slits (213) generates an ion beam with an elongated cross-section, which is defined by the elongated section of the slits (213). This type of ion beam is ideal to match Ion Mobility Spectrometers with planar geometries, such as the VEFMA described in U.S. Pat. No. 8,378,297 B2 or the planar DMA (described in U.S. Pat. No. 7,928,374 B2), which usually have an inlet with the shape of a slit.

An alternative embodiment of the TDR Filter, which is illustrated in FIG. 10 and which is termed axial TDR (232), comprises a ladder of planar electrodes (234) filled with a gas. The first planar electrode (235) has a first slit of orifice (236), which defines the inlet (202). The second planar electrode (237) has a second slit or orifice, and a voltage drop between said first planar electrode (235) and said second planar electrode (237) generates a local axial electric field (215) that pushes the ions that are imputed through said inlet (202) towards said slit or orifice (236) of said second planar electrode (237). The third electrode (238) also has a slit or orifice (236), and the voltage drop between the second electrode and the third electrode generates a local axial electric filed (215) that pushes the ions towards said third orifice (236). By repeatedly adding more planar electrodes (234) and more axial voltage drops, a channel (203) is formed in the space defined by the subsequent slits or orifices (236), and an axial electric (204) field that guides the ions along said channel (203) through the consecutive slits or orifices (236) is also defined. The last planar electrode (239) define a slit or orifice (236) which defines the outlet (205).

Since each slit or orifice (236) is defined only by one planar electrode (234), it is not possible to create a transversal electric field to eliminate the ions. Instead, in this embodiment of the invention, the Depletion Regions (222) are accomplished by increasing or lowering the voltage of one electrode, while the voltage of the surrounding electrodes is kept constant. By increasing the voltage of an electrode by a magnitude higher than the voltage drop normally applied between adjacent electrodes, the resulting electric field (240) between the previous electrode and the electrode which's voltage is increased, changes direction. And, as a result, ions which would normally be pushed forwards, are now pushed backwards and towards the previous electrode in the region defined between the previous electrode and the electrode which's voltage is increased. Alternatively, by decreasing the voltage of an electrode by a magnitude higher than the voltage drop normally applied between adjacent electrodes, the resulting electric field (240) between the next electrode and the electrode which's voltage is increased, changes sign. And, as a result, ions which would normally be pushed forwards, are now pushed backwards and towards the electrode which's voltage is increased in the region defined between the next electrode and the electrode which's voltage is increased.

The slits or orifices in the planar electrodes can be of any arbitrary shape (For instance, Wire Electric Discharge Machining, or Laser Cutting can be used to cut any arbitrary shape in a plate). Resulting from this, this configuration has the advantage of being able to produce an ion beam of any required cross section (which is defined by the shape of the slits or orifices). However, the electric filed in the central part of the channel has a stagnated zone, in which ions are not efficiently deflected laterally.

Synchronization Between the TDR Filter, and the VEFMA:

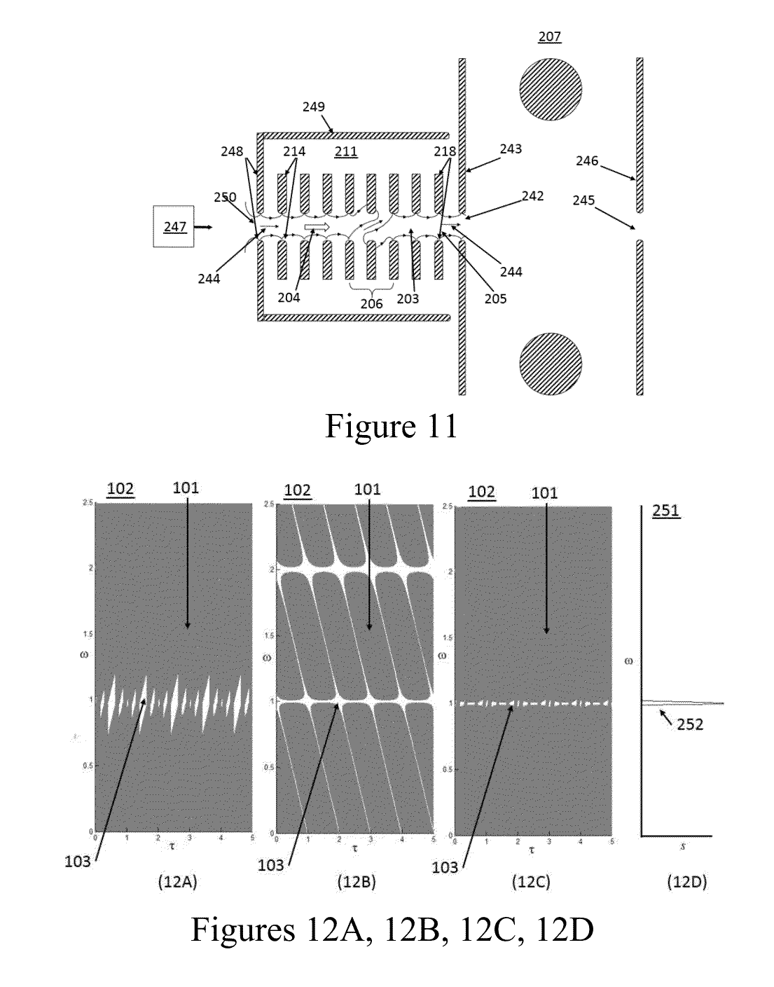

Since the inlet of the VEFMA described in U.S. Pat. No. 8,378,297 B2 is a slit, the VEFMA is preferably coupled with the Transversal TDR. FIG. 11 illustrates schematically the mechanical coupling between the Transversal TDR (211) and the VEFMA (207). The transversal TDR (211) and the VEFMA (207) are coupled by assembling the outlet (205) slit of the Transversal TDR (211) in front of the inlet of the VEFMA (242), and by applying a voltage drop between the last pair of electrodes (218) of the Transversal TDR and the inlet electrode (243) of the VEFMA, so as to generate a local electric field (244) that pushes the ions outputted by the Transversal TDR (211) towards the inlet slit (242) of the VEFMA. Alternatively, the Transversal TDR (211) can be coupled downstream the VEFMA (207) by assembling the inlet slit (202) of the Transversal TDR in front of the outlet slit (245) of the VEFMA, and by applying a voltage drop between the outlet electrode (246) of the VEFMA and the first pair of electrodes (212) of the Transversal TDR (211), so as to create an electric field (244) that pushes the ions outputted by the VEFMA towards the inlet of the Transversal TDR. FIG. 11 illustrates the coupling between the Transversal TDR (211) and the VEFMA (207), in which the Transversal TDR (211) is upstream the VEFMA (207). Ions arriving at the Transversal TDR (211) are produced by an ion source (247), which can be an Electro-Spray Ionizer, a Secondary Electro-Spray Ionizer, a Low Flow Secondary Electro-Spray Ionizer, an Atmospheric Pressure Photo-Ionization Source, an Atmospheric Pressure Chemical Ionization source, a Radioactive Source, a Corona, or a plasma Source, or any other ionization source operating under the presence of a gas. Ions can also be delivered by another analyzer, such as a Gas Chromatographer, a Liquid Chromatographer, an Electrophoretic Capillary, or other analyzers not requiring vacuum. In order to ease the coupling of the Transversal TDR (211) with the source of ions (247), a separation plate (248) separates the source of ions (247) and the first pair of electrodes (214), so as to shield the ion source (247) from the varying electric fields generated by the Transversal TDR (211). Additionally, an enclosing conductive box (249) can be used to minimize electromagnetic radiation produced by the varying electric fields generated by the pairs of electrodes (212) of the Transversal TDR (211). An inlet slit (250) is defined in the separation plate (249), and a voltage drop between said separation plate (249) and the first pair of electrodes (214) creates a local electric field (244) that pushes the ions towards the inlet (202) of the Transversal TDR (211). Once in the channel (203), ions are pushed forward by the axial electric field (204) generated by the successive voltage drops generated between each consecutive pair of electrodes. Ions travel at a velocity which is proportional to their mobility, and only ions which travel at the same velocity as the virtual Travelling Depletion Regions (229) reach the outlet (205) slit of the channel (203), which is defined by the last pair of electrodes (218).

According to the present invention, the repetition time T, of the transversal TDR (211) is equal to the period of oscillation of the deflector electric fields of the VEFMA (207) so as to ensure that the VEFMA (207) and the Transversal TDR (211) operate synchronously. Also, the time Tₗ (the time required for each TDR to traverse the channel) is defined to ensure that the mobility which is preferentially transmitted by the TDR (211) equals the mobility selected by the VEFMA (207). In order to achieve this condition, the ratio of the time Tᵣ over the time Tₗ must satisfy the following equation:

$$\frac{{T}_{r}}{{T}_{l}} = \frac{{l}_{timims}}{{l}_{tdr}} \frac{{E}_{tdr}}{{E}_{tmins}} \qquad ( e 13 )$$

Where lₜₘᵢₘₛ is the distance between the axial electrodes of the VEFMA, l_{tdr} is the length of the channel (203), E_{tdr} is the mean axial electric field along the channel (203), and Eₜₘᵢₘₛ is the axial electric field within the VEFMA.

The FIG. 12A illustrates the conditions for which ions are transferred through a transversal TDR that utilizes four different phases: (φ₁=0, φ₂=0.15, φ₃=0.4, φ₄=0.7), FIG. 12B illustrates the conditions for which ions are transferred through the VEFMA, and FIG. 12C illustrates the conditions for which ions are transferred through the TDR and the VEFMA. In these figures, ω and τ are defined as follows:

The dimensionless parameter ω is the ratio of the time required by the ions to traverse the TDR channel over the time Tₗ, which equals the ratio of the time required by the ions to traverse the VEFMA over the time Tᵣ:

$$ω = \frac{{V}_{d}}{{ZE}_{tdr}} = \frac{{l}_{tmims}}{{T}_{r} {ZE}_{tmims}} \qquad ( e 14 )$$

The dimensionless parameter τ is the ratio of the natural time over the Tᵣ (Note that, because the TDR and the VEFMA are synchronized, the time Tᵣ is the repetition time of the TDR and also the period of oscillation of the VEFMA):

τ=t/Tᵣ (e15)

The shadowed regions (101) of the ω-τ domain (102) correspond with ions that are not transferred, while the clear regions (103) correspond with ions that are transferred. Finally, FIG. 12D represents the resulting spectrum (251) produced by the combination of the transversal TDR (211) and the VEFMA (207), in which only one main peak (252) is produced at the fundamental frequency (105). As evidenced by FIGS. 12A, 12B and 12C, the synchronized transversal TDR eliminates the undesired pulsed output produced by the VEFMA and also the overtones. The Transversal TDR (211) alone would pass a very wide band of mobilities, which would make it unusable as a mobility filter. But, combined together, the Transversal TDR (211) and the VEFMA (207) produce clean spectra (251) with a high Duty Cycle, without overtones and secondary peaks, and with a high resolving power. And they also enable for the transparent mode.

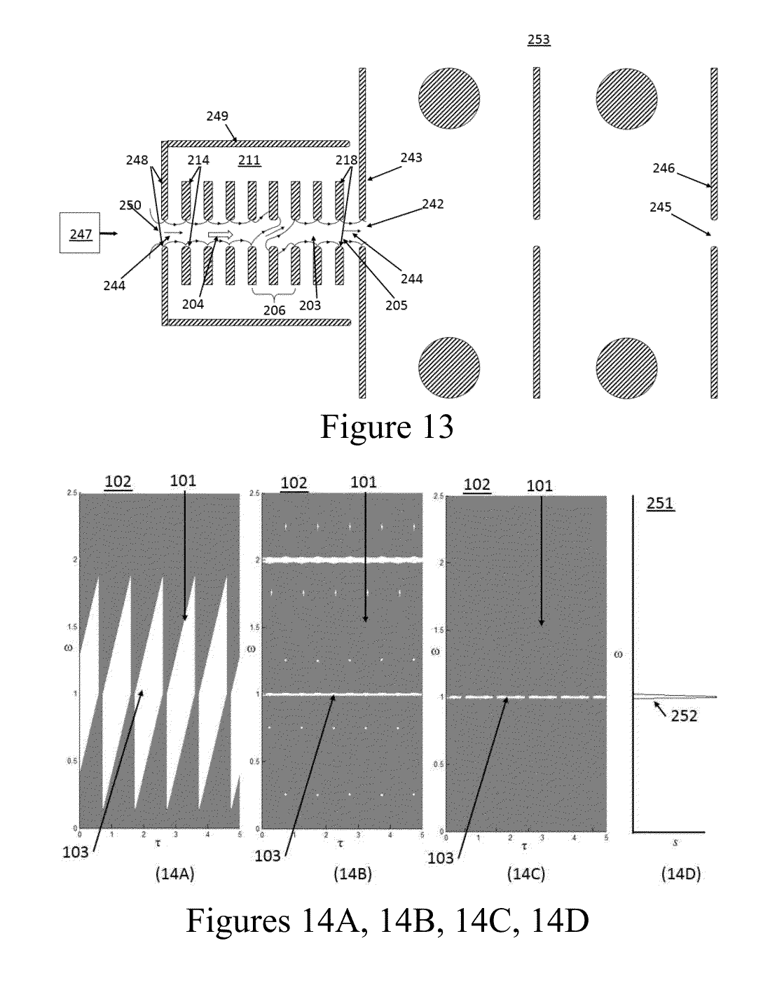

The FIG. 13 illustrates an alternative embodiment of the present invention, in which a two stages VEFMA (253) is utilized in tandem with a transversal TDR (211). FIG. 14A illustrates, in the ω-τ domain (202), the conditions for which ions are transferred through a transversal TDR with only one TDR travelling at a time. FIG. 14B illustrates, in the ω-τ domain (202), the conditions for which ions are transferred through a two stages VEFMA (253). And FIG. 14C illustrates, in the ω-τ domain (202), the conditions for which ions are transferred through a transversal TDR with only one TDR travelling at a time, combined with a two stages VEFMA. The shadowed areas (101) of the ω-τ domain (102) represent the ions which are not transferred, while the clear areas (103) represent the ions which are transferred. FIG. 14D represents the resulting spectrum (251) produced by the combination of the transversal TDR (211) and the two stages VEFMA (253), in which only one main peak (252) is produced at the fundamental frequency (105), and in which overtone peaks and secondary peaks are eliminated. As evidenced by these figures, the combined Transversal TDR-VEFMA produces a spectra with a high duty cycle, a high resolving power, and without the problematic overtones and secondary peaks produced by the two stages VEFMA.

Other combinations of TDR Filters (including the Transversal TDR and the Axial TDR), with other number of TDR and/or different VEFMA stages, can also produce the desired effect of eliminating the pulsed output, the secondary peaks, and the overtones, and these configurations are also included in the present invention.

By switching of the deflection electric fields of the VEFMA (207) or the two stages VEFMA (253), it transfers all ions regardless of their mobility. Similarly, by switching off the voltages that provide the transversal electric fields in the transversal TDR (211), all ions are continuously transferred through the TDR Filter regardless of their mobility. As a result, the combination of the TDR and the VEFMA also can also be operated in transparent mode.

In short, the combination of a TDR Filter with a VEFMA of the present invention enables us to: produce an output of mobility selected ions with high transmission and high duty cycle, and high resolving power; operate in transparent mode (transferring all ions regardless of their mobility) as VEFMA. Yet, the combination of the Transversal TDR and the VEFMA also eliminates the overtones and secondary peaks produced by VEFMA alone. As a result, the combined Transversal TDR-VEFMA produce a one-to-one correspondence between the frequency of operation of the TDR-VEFMA and the mobility.

Synchronization Between the TDR Filter, and the OMS:

The TDR Filter can also be coupled with an OMS simply by assembling the outlet of the TDR Filter in front of the inlet of the OMS and by applying a voltage drop between the outlet of the TDR Filter and the inlet of the OMS so as to push the ions outputted by the TRD Filter towards the OMS. In an alternative embodiment of the present invention, the TDR filter can also be coupled downstream the OMS by assembling the outlet of the OMS in front of the inlet of the TDR filter and by applying a voltage drop between the outlet of the OMS and the inlet of the TDR Filter so as to drive the ions outputted by the OMS towards the TDR filter. In order to synchronize the TDR Filter and the OMS, the time Tᵣ and the period (the inverse of the frequency) of the OMS have to be equal. By tuning the time Tₗ (the time required for each TDR to traverse the channel) the different tones of the OMS spectra can be selected.

High Resolution TDR Filter:

Not accounting for diffusional effects, the resolving power of the TDR Filter can be estimated as the ratio between the widths of the mobility band, which is passed by the TDR Filter, over the mobility for which the DC is maximized. According to equation e12, and introducing the parameter δ=T_{d}V_{d}−d, the resolving power can be estimated as:

$$R = \frac{{t}^{2} - {δ}^{2}}{l δ} \qquad ( e 16 )$$

Introducing the same parameter δ in eq. (e11), the Duty cycle of the ions which are preferentially transmitted by the TDR Filter can be estimated as:

$$DC = \frac{1}{1 + \frac{d}{δ}} \qquad ( e 17 )$$

In view of these expressions, the resolving power can be improved either by increasing l or by reducing δ. Reducing δ also has the negative effect of reducing the DC (which in turn reduces the transmission of selected ions). Nevertheless, this effect can be mitigated by ensuring that d is sufficiently low. For instance, according to the present invention, a Transversal TDR comprising 100 pairs of electrodes separated 1 mm (d=1 mm) produces channel 100 mm long (l=100 mm). By selecting T_{d}V_{d} (which are fully tunable) so that δ=1 mm, the resulting DC would be 50%, and the resulting Resolving power is nearly R=100. Of course, the final resolving power and the transmission is limited by other effects, including diffusional broadening and coulombic repulsion effects (which are not accounted for in these estimations). Nevertheless, these effects provide a limit which is typically in the range of 100 for most State of the Art IMS analyzers, and therefore the final resolving power (considering all limiting factors) will be also in the order of 100.

The TDR Filter can be coupled with other types of analyzers, including Mass Spectrometers, other IMS analyzers, including Drift Tube IMS, Travelling Wave IMS, FAIMS, DMS, DMA OMS, and VEFMA. More than one TDR can be coupled in series to provide pre-filtration according to the mobility in more than one type of media. Alternatively, an excitation stage can be incorporated between the TDR Filter and other IMS analyzer in order to modify the analyte ions so as to pre-filter the analyte ions in two different circumstance. The excitation stage can be provided by a laser, a radioactive source, a source of heat, a region with intense electric fields, which induce high energy collisions, or other types of excitation stages, which are well known for those skilled in the art.

Note that, although the term ions is used through the present description, the new invention can be used to classify all types of charged particles, including charged droplets, aerosols, nanoparticles and nano-droplets, proteins and other macromolecules, protein complexes, aerosolized viruses, and other particles that can be easily identified by those skilled in the art.

U.S. PATENTS AND APPLICATIONS CITED
U.S. Pat. No. 5,936,242 A; Method and apparatus for separation of ions in a gas for mass spectrometry; Juan Fernandez De La Mora, Luis De Juan, Thilo Eichler, Joan Rosell; Jun. 27, 1996.
U.S. Pat. No. 7,928,374 B2; Resolution improvement in the coupling of planar differential mobility analyzers with mass spectrometers or other analyzers and detectors; Juan Rus-Perez, Juan Fernandez De La Mora; Apr. 10, 2006.
U.S. Pat. No. 7,838,821 B2; Ion mobility spectrometer instrument and method of operating same; David E. Clemmer, Ruwan T. Kurulugama, Fabiane M. Nachtigall, Zachary Henson, Samuel I. Merenbloom, and Stephen J. Valentine; Jan. 17, 2008.
U.S. Pat. No. 8,378,297 B2; Method and apparatus to produce steady beams of mobility selected ions via time-dependent electric fields; G. Vidal de Miguel; Mar. 30, 2009.

### OTHER DOCUMENTS CITED

1. Eiceman, G. A. and Z. Karpas, Ion Mobility Spectrometry. 2004.
2. Tang, K., et al., Two-Dimensional Gas-Phase Separations Coupled to Mass Spectrometry for Analysis of Complex Mixtures. Analytical Chemistry, 2005. 77(19): p. 6381-6388.
3. Kurulugama, R., et al., Overtone Mobility Spectrometry: Part 4. OMS-OMS Analyses of Complex Mixtures. Journal of The American Society for Mass Spectrometry, 2011. 22(11): p. 2049-2060.
4. Li, Z., S. Valentine, and D. Clemmer, Complexation of Amino Compounds by 18C6 Improves Selectivity by IMS-IMS-MS: Application to Petroleum Characterization. Journal of The American Society for Mass Spectrometry, 2011. 22(5): p. 817-827.
5. Ponthus, J. and E. Riches, Evaluating the multiple benefits offered by ion mobility-mass spectrometry in oil and petroleum analysis. International Journal for Ion Mobility Spectrometry, 2013. 16(2): p. 95-103.
6. Valentine, S. J., et al., Toward Plasma Proteome Profiling with Ion Mobility-Mass Spectrometry. Journal of Proteome Research, 2006. 5(11): p. 2977-2984.
7. Liu, X., et al., Mapping the Human Plasma Proteome by SCX-LC-IMS-MS. Journal of the American Society for Mass Spectrometry, 2007. 18(7): p. 1249-1264.
8. Smith, D. P., et al., Monitoring Copopulated Conformational States During Protein Folding Events Using Electrospray Ionization-Ion Mobility Spectrometry-Mass Spectrometry. Journal of the American Society for Mass Spectrometry, 2007. 18(12): p. 2180-2190.
9. Shvartsburg, A. A., et al., Characterizing the Structures and Folding of Free Proteins Using 2-D Gas-Phase Separations: Observation of Multiple Unfolded Conformers. Analytical Chemistry, 2006. 78(10): p. 3304-3315.
10. Ruotolo, B. T., et al., Ion mobility-mass spectrometry reveals long-lived, unfolded intermediates in the dissociation of protein complexes. Angew Chem Int Ed Engl, 2007. 46(42): p. 8001-4.
11. Kaddis, C. S., et al., Sizing Large Proteins and Protein Complexes by Electrospray Ionization Mass Spectrometry and Ion Mobility. Journal of the American Society for Mass Spectrometry, 2007. 18(7): p. 1206-1216.
12. Hogan Jr, C. J., et al., Ion mobility-mass spectrometry of phosphorylase B ions generated with supercharging reagents but in charge-reducing buffer. Physical Chemistry Chemical Physics, 2010. 12(41): p. 13476-13483.
13. Hogan, C. J., et al., Tandem Differential Mobility Analysis-Mass Spectrometry Reveals Partial Gas-Phase Collapse of the GroEL Complex. The Journal of Physical Chemistry B, 2011. 115(13): p. 3614-3621.
14. Hogan, C., Jr. and J. de la Mora, Ion Mobility Measurements of Nondenatured 12-150 kDa Proteins and Protein Multimers by Tandem Differential Mobility Analysis—Mass Spectrometry (DMA-MS). Journal of The American Society for Mass Spectrometry, 2011. 22(1): p. 158-172.
15. Martínez-Lozano, P., et al., Differential mobility analysis-mass spectrometry coupled to XCMS algorithm as a novel analytical platform for metabolic profiling. Metabolomics, 2013. 9(1): p. 30-43.
16. Revercomb, H. E. and E. A. Mason, Theory of Plasma Chromatography Gaseous Electrophoresis—Review. Analytical Chemistry, 1975. 47(7): p. 970-983.
17. Giles, K., et al., Applications of a travelling wave-based radio-frequency-only stacked ring ion guide. Rapid Communications in Mass Spectrometry, 2004. 18(20): p. 2401-2414.
18. Tang, K., et al., High-Sensitivity Ion Mobility Spectrometry/Mass Spectrometry Using Electrodynamic Ion Funnel Interfaces. Analytical Chemistry, 2005. 77(10): p. 3330-3339.
19. Belov, M. E., et al., Multiplexed Ion Mobility Spectrometry-Orthogonal Time-of-Flight Mass Spectrometry. Analytical Chemistry, 2007. 79(6): p. 2451-2462.
20. Purves, R. W., et al., Mass spectrometric characterization of a high-field asymmetric waveform ion mobility spectrometer. Review of Scientific Instruments, 1998. 69(12): p. 4094-4105.
21. Guevremont, R., High-field asymmetric waveform ion mobility spectrometry: A new tool for mass spectrometry. Journal of Chromatography A, 2004. 1058(1-2): p. 3-19.
22. Schneider, B. B., et al., Planar differential mobility spectrometer as a pre-filter for atmospheric pressure ionization mass spectrometry. International Journal of Mass Spectrometry, 2010. 298(1-3): p. 45-54.
23. Krylov, E. V. and E. G. Nazarov, Electric field dependence of the ion mobility. International Journal of Mass Spectrometry, 2009. 285(3): p. 149-156.
24. Eiceman, G. A., et al., Separation of Ions from Explosives in Differential Mobility Spectrometry by Vapor-Modified Drift Gas. Analytical Chemistry, 2004. 76(17): p. 4937-4944.
25. Coy, S. L., et al., Detection of radiation-exposure biomarkers by differential mobility prefiltered mass spectrometry (DMS-MS). International Journal of Mass Spectrometry, 2010. 291(3): p. 108-117.
26. Knutson, E. O. and K. T. Whitby, Aerosol classification by electric mobility: apparatus, theory, and applications. Journal of Aerosol Science, 1975. 6(6): p. 443-451.
27. Fernandez de la Mora, J., B. A. Thomson, and M. Gamero-Castano, Tandem mobility mass spectrometry study of electrosprayed tetraheptyl ammonium bromide clusters. J Am Soc Mass Spectrom, 2005. 16(5): p. 717-32.
28. Marti'nez-Lozano, P. and J. F. d.l. Mora, Effect of acoustic radiation on DMA resolution. Aerosol science and technology, 2005. 39(9): p. 866-870.
29. Martínez-Lozano, P. and J. F. de la Mora, Resolution improvements of a nano-DMA operating transonically. Journal of Aerosol Science, 2006. 37(4): p. 500-512.
30. Kurulugama, R. T., et al., Overtone Mobility Spectrometry: Part 1. Experimental Observations. Journal of the American Society for Mass Spectrometry, 2009. 20(5): p. 729-737.
31. Valentine, S. J., et al., Overtone Mobility Spectrometry: Part 2. Theoretical Considerations of Resolving Power. Journal of the American Society for Mass Spectrometry, 2009. 20(5): p. 738-750.
32. Valentine, S., R. Kurulugama, and D. E. Clemmer, Overtone Mobility Spectrometry: Part 3. On the Origin of Peaks. Journal of The American Society for Mass Spectrometry, 2011. 22(5): p. 804-816.
33. Ewing, M., et al., Overtone Mobility Spectrometry: Part 5. Simulations and Analytical Expressions Describing Overtone Limits. Journal of The American Society for Mass Spectrometry, 2013. 24(4): p. 615-621.
34. Vidal-de-Miguel, G., M. Macia, and J. Cuevas, Transversal Modulation Ion Mobility
Spectrometry (TM-IMS), a new mobility filter overcoming turbulence related limitations. Anal Chem, 2012. 84(18): p. 7831-7.
35. Ude, S. and J. F. de la Mora, Molecular monodisperse mobility and mass standards from electrosprays of tetra-alkyl ammonium halides. Journal of Aerosol Science, 2005. 36(10): p. 1224-1237.

What is claimed is:

1. An apparatus to produce a beam of ions with a controlled range of mobilities, said apparatus comprising a channel filled with a gas, an inlet defined at one end of said channel, and an outlet defined at the opposite side of said channel, a set of electrodes arranged along said channel, and powered with increasing or decreasing voltages so as to produce an axial electric field along said channel, and a set of travelling depletion regions which travel along said channel, which are generated periodically with a controlled period, and which travel along said channel with a controlled velocity,
wherein said electric field is characterized in that it pushes all ions along said channel from said inlet and towards said outlet,
wherein said travelling depletion regions travel with the same direction as said ions, and
wherein said period and said velocity are tunable so as to select the lower and the upper limits of said ranges of mobilities which are transferred through said apparatus.
